(19) United States
(12) Patent Application Publication
(10) Pub. No.: US 2023/0218943 A1
(43) Pub. Date: Jul. 13, 2023

(54) Composite Exercise Weights

(71) Applicant: Paradigm Barbell Inc., Fort Worth, TX (US)

(72) Inventor: Phillip Cavanaugh Diffley, Fort Worth, TX (US)

(21) Appl. No.: 18/001,210

(22) PCT Filed: Jun. 8, 2021
(86) PCT No.: PCT/US21/36432

§ 371 Date: Dec. 8, 2022

Related U.S. Application Data
(60) Provisional application No. 63/037,167, filed on Jun. 10, 2020.
(60) Provisional application No. 63/068,110, filed on Aug. 20, 2020.
(60) Provisional application No. 63/081,552, filed on Sep. 22, 2020.

(51) Int. Cl. A63B 21/06

(52) U.S. Cl. CPC A63B 21/0607

(57) ABSTRACT

A method is provided for fabricating a unitary element, such as an exercise weight, including a composite material. The method includes providing a plurality of solid fragments including at least one non-thermoplastic material. The method further includes providing a plurality of solid particles including at least one thermoplastic polymer and/or elastomer material, at least 75% of the solid fragments having sizes in a fragment size range from zero to 32 millimeters and at least 75% of the solid particles having sizes in a article size range from zero to 1.5 millimeters. The method further includes forming a mixture of the plurality of solid fragments and the plurality of solid particles, the mixture including 90% to 20% of the fragments by volume and 10% to 80% of the particles by volume. The method further includes molding or extruding the mixture into a unitary element through the application of heat and/or pressure.

### CLAIM OF PRIORITY

This application claims the benefit of priority to U.S. Provisional Appl. Nos. 63/081,552 filed Sep. 22, 2020, 63/068,110 filed Aug. 20, 2020, and 63/037,167 filed Jun. 10, 2020, which are each hereby incorporated herein in their entireties by reference.

### BACKGROUND

### Field

This application relates generally to exercise weights.

### Description of the Related Art

Weights are essential pieces of equipment for a variety of sports, exercise, and fitness routines. Examples of conventional materials used for forming weights include but are not limited to: cast iron, machined steel, rubber, and encased sand or water, and each of these materials has different benefits and drawbacks.

Cast iron is the most common material used to make weights. It is very dense and is usually durable enough for typical gym use. It is relatively inexpensive to produce but has high energy requirements for melting and molding the iron.

Machined steel and/or cast iron can be used to create an extremely accurate weight. The machined metal has comparable density to ordinary cast iron. These weights are expensive to produce and are typically used for competition level plates with tight weight tolerances.

Rubber weights can be made from elastomers such as vulcanized rubber or masticated rubber. Rubber can be a reasonably dense material. These weights are typically used as bumper plates and are designed to be dropped safely. These weights typically cost more than a comparable cast iron weight.

Encased weights comprise an outer casing filled with a heavy material such as sand or water. An example is a sandbag. Sandbags are typically used for niche exercises such as carrying a heavy bag over the shoulder. There are also casings shaped like standard weight plates or dumbbells, but these are rarely used in a gym setting. These weights are less dense and typically much more fragile than a cast iron weight. Concrete weights can be made from cement mixed with concrete aggregate. Like encased weights, these weights tend to be bulky and fragile, and are therefore rarely if ever used in a gym setting.

### SUMMARY

In one aspect described herein, a method is provided for fabricating a unitary element comprising a composite material. The method comprises providing a plurality of solid fragments comprising at least one non-thermoplastic material. The method further comprises providing a plurality of solid particles comprising at least one thermoplastic polymer and/or elastomer material, at least 75% of the solid fragments having sizes in a fragment size range from zero to 32 millimeters and at least 75% of the solid particles having sizes in a particle size range from zero to 1.5 millimeters. The method further comprises forming a mixture of the plurality of solid fragments and the plurality of solid particles, the mixture comprising 90% to 20% of the fragments by volume and 10% to 80% of the particles by volume. The method further comprises molding or extruding the mixture into a unitary element through the application of heat and/or pressure.

In another aspect described herein, an exercise weight is provided. The exercise weight comprises a plurality of fragments comprising at least one first solid material with a first mass density greater than 3500 kg/m³. The exercise weight further comprises a matrix that binds the plurality of fragments to one another, the matrix comprising a thermoplastic polymer and/or elastomer. The exercise weight comprises 90% to 20% of the fragments by volume and 10% to 80% of the matrix by volume.

In another aspect described herein, an exercise weight is provided. The exercise weight comprises a plurality of fragments comprising at least one first solid material with a first mass density greater than 3500 kg/m³. The exercise weight further comprises a matrix that binds the plurality of fragments to one another, the matrix comprising a thermoset polymer and/or elastomer. The exercise weight comprises 90% to 20% of the fragments by volume and 10% to 80% of the matrix by volume.

### BRIEF DESCRIPTION OF THE DRAWINGS

FIGS. 1A-1H illustrates various examples of exercise weights compatible with certain implementations described herein.

FIG. 2 schematically illustrates a portion of an example exercise weight in accordance with certain implementations described herein.

FIGS. 3A-3C schematically illustrate example methods for fabricating a weight in accordance with certain implementations described herein.

FIG. 4 schematically illustrates an example mold containing the mixture in accordance with certain implementations described herein.

FIGS. 5 and 6 are flow diagram of two example methods in accordance with certain implementations described herein.

### DETAILED DESCRIPTION

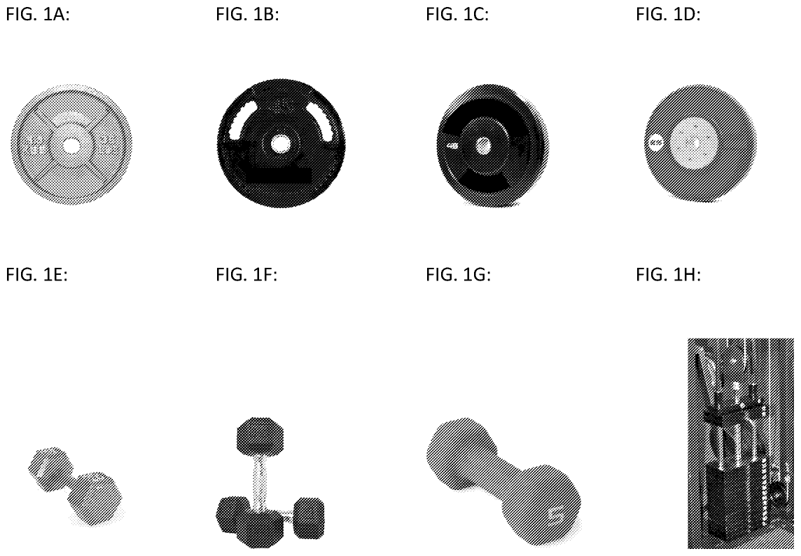

FIGS. 1A-1H illustrates various examples of exercise weights compatible with certain implementations described herein. FIG. 1A shows a weight plate, FIG. 1B shows a weight plate with an outer coating, FIG. 1C shows a bumper plate with a stainless-steel ring insert, FIG. 1D shows a bumper plate with a machined steel insert, FIG. 1E shows a dumbbell, FIG. 1F shows dumbbells with an outer coating and a chromed steel handle, FIG. 1G shows a neoprene coated dumbbell, and FIG. 1H shows a stack of weight plates that are part of an exercise machine. While the examples of FIGS. 1A-1H comprise conventional materials such as cast iron, stainless-steel, or rubber, certain implementations described herein provide exercise weights comprising at least one composite material and provide methods for forming such exercise weights.

The materials used to make exercise weights have multiple constraints, which conventional weight materials satisfy to various levels:
Accuracy: To use weights safely and effectively, the user should know how heavy the weights are. Weights can be manufactured to have a specific mass, so the material used is able to produce weights of a consistent size.
Durability: Weights can be durable enough to not break under typical use. In addition to posing a financial burden for the owner, a weight breaking poses a safety risk to the user. Some weights are not intended to be dropped from a height but can be strong enough to endure accidental droppage as well as being set heavily on the ground. Other weights are intended to be dropped, and these weights can be resilient enough to be dropped repeatedly from a height without breaking and can be cushioned or elastic enough to not damage the surface they are dropped on.
Density: Weights can be quite heavy. For example, weight plates can weigh 10, 25, 35, or 45 pounds. The materials the weights are made from can be sufficiently dense so that the resulting weight is not so large as to be cumbersome.
Formability: Weights come in a variety of shapes and sizes (e.g., weight plates shaped to be used with a barbell; weight plates made to be stacked for use in weightlifting machines, kettlebells and dumbbells). To use a material in a variety of weight types, the material can be capable of being formed into the predetermined shape and size.
Price: Weights can be expensive, often because of the sheer amount of material used to make them and the cost of forming that material into the appropriate shape. Therefore, the material used for the weight can be cost effective, both to purchase in raw form and to form into the shape of a weight.

Certain implementations described herein provide methods for creating and/or molding a composite material comprising at least one binding agent and at least one bulk material, as well as the application of these methods to the creation of weights such as those used for sports and/or exercise.

Certain implementations described herein provide a benefit of making weights with the composite material using two or more materials which by themselves would not be suitable for making weights and combining them to make an effective weight. For example, a durable binding agent that is easy to mold but that is not very dense can be combined with a dense bulk material that would be expensive to form or mold. Using the binding agent to hold the dense bulk material together in the desired shape can provide the benefit of making a dense durable weight that is less expensive to produce than a weight made from a single material which possesses some or all of the desired characteristics. The materials and methods used to manufacture weights in certain implementations described herein are more cost effective and energy efficient than are conventional materials and methods and can result in weights that are dense, durable, and accurate.

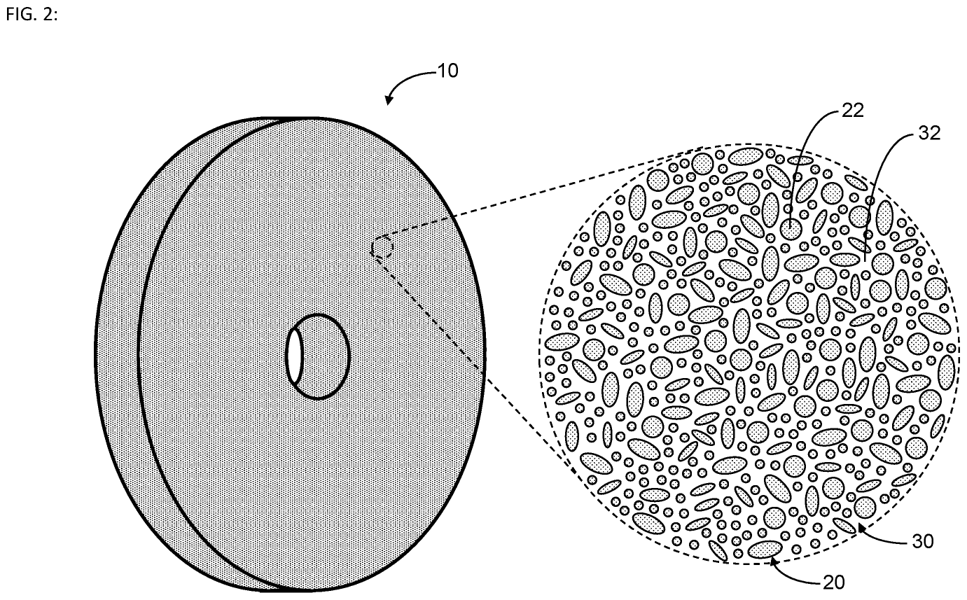

FIG. 2 schematically illustrates a portion of an example exercise weight 10 in accordance with certain implementations described herein. The exercise weight 10 comprises a plurality of fragments 20 comprising at least one first solid material 22 with a first mass density greater than 2500 kg/m³ (e.g., greater than 3500 kg/m³). The exercise weight 10 further comprises a matrix 30 that binds the plurality of fragments 20 to one another. The matrix 30 comprises at least one second material 32 comprising at least one of: at least one thermoplastic polymer, at least one thermoplastic elastomer, at least one thermoset polymer, at least one thermoset elastomer. The exercise weight 10 can comprise 90% to 20% of the fragments by volume and 10% to 80% of the matrix by volume. In certain implementations, the at least one second material 32 has a second mass density less than the first mass density.

The at least one first solid material 22 of certain implementations is configured to increase the mass density of the exercise weight 10 (e.g., the at least one first solid material 22 can constitute most of the mass of the exercise weight 10). In certain implementations, the fragments 20 have a range of fragment sizes, the size of a fragment being the value of the maximum linear dimension (e.g., length, width, and/or thickness) of the fragment. In certain implementations, the range of fragment sizes is less than or equal to 2 millimeters. For example, the plurality of fragments 20 can comprise powder (e.g., fragment sizes less than 1 millimeter), sand (e.g., fragment sizes less than 2 millimeters), medium sand (e.g., fragment sizes in a range of 0.25 millimeter to 0.5 millimeter), coarse sand (e.g., fragment sizes in a range of 0.5 millimeter to 1 millimeter), and/or very coarse sand (e.g., fragment sizes in a range of 1 millimeter to 2 millimeters). In certain implementations, the fragments 20 have a range of fragment sizes that is greater than 2 millimeters. For example, the plurality of fragments 20 can comprise gravel (e.g., fragment sizes in a range of 2 millimeters to 64 millimeters), very fine gravel (e.g., fragment sizes in a range of 2 millimeters to 4 millimeters), fine gravel (e.g., fragment sizes in a range of 4 millimeters to 8 millimeters), medium gravel (e.g., fragment sizes in a range of 8 millimeters to 16 millimeters), and/or coarse gravel (e.g., fragment sizes in a range of 16 millimeters to 32 millimeters). In certain implementations, the plurality of fragments 20 comprises chips, filings, and/or shreddings of man-made materials (e.g., scrap metal). In certain implementations, the plurality of fragments 20 comprises a mixture of fragments having sizes that are less than or equal to 2 millimeters and fragments 20 having sizes that are larger than 2 millimeters.

In certain implementations, the at least one first solid material 22 comprises one or more materials selected from the group consisting of: ores; iron ores (e.g., magnetite, hematite, goethite, limonite, and siderite); metals (e.g., iron; aluminum); ferrous and non-ferrous metal and/or scrap metal; ferrous and non-ferrous turnings from scrap material; shredded and/or milled scrap material. In certain implementations, the at least one first solid material 22 comprises a material having a first mass density greater than 3500 kg/m³. In certain implementations, the at least one first solid material 22 further comprises additional materials (e.g., fillers; binding agents) that do not have a first mass density greater than 2500 kg/m³.

While typically less dense than the metal that can be extracted from them, ores are sufficiently dense to be used as a first solid material 22 as described herein. For example, magnetite (e.g., iron ore) has a specific gravity of about 5.18 which is heavier than some metals (e.g., aluminum). Ores are also less expensive than the metal that can be extracted from them because of the energy and equipment costs associated with the metal extraction. Because ores have not undergone energy intensive smelting, using ores can be more environmentally friendly than using their associated metal. The use of ore can also be more environmentally friendly than the use of scrap metal because using ore does not increase demand for smelted metal. In addition, iron ore can be less expensive than ores of other metals (e.g., aluminum) and is widely available (e.g., due to the high industrial use of iron). Ores can also be easily broken, crushed, and/or pulverized to a predetermined fragment size, facilitating obtaining ore in a form compatible with fabricating the exercise weights as described herein (e.g., blending with a binding agent and transferring to a mold). For example, ore fragments with a sand-like fragment size can fit in a mold more easily than can larger fragments.

Scrap metal is another first solid material 22 compatible with certain implementations described herein. For example, metals are sufficiently dense (e.g., cast iron and steel each have a specific gravity of about 7.2), the cost of scrap metal is lower than the cost of extracting metal from ore, and scrap metal can be shredded or milled down to a predetermined size, facilitating obtaining scrap metal in a form (e.g., chips; filings) compatible with fabricating the exercise weights as described herein (e.g., blending with a binding agent and transferring to a mold).

In certain implementations, the at least one first solid material 22 comprises a single type of fragments 20 having a single first solid material 22, while in certain other implementations, the at least one first solid material 22 comprises multiple types of fragments 20 and/or multiple first solid materials 22. Examples compatible with certain implementations described herein include but are not limited to: magnetite sand and magnetite gravel; magnetite sand and shredded and/or milled steel; other combinations of the materials described herein. By including fragments 20 having a plurality of fragment sizes (e.g., multiple consistencies), certain implementations described herein facilitate reduction of the amount of the at least one second material 32 to be used in the matrix 30 and increase of the overall density of the exercise weight 10. For example, an exercise weight 10 comprising magnetite gravel and magnetite sand can use less second material 32 than does an exercise weight 10 comprising only magnetite sand. By including fragments 20 having a plurality of first solid materials 22, certain implementations described herein facilitate advantageous combinations of different material properties. For example, steel scrap chips are denser than magnetite, but reducing steel to a powdered form is more expensive than reducing magnetite to a sand-like consistency. For the plurality of fragments 20 comprising a combination of steel scrap chips (e.g., having a gravel-like consistency or fragment size) with magnetite sand can benefit from the extra mass density of the steel as well as the crushability of magnetite.

In certain implementations, the at least one second material 32 of the matrix 30 is configured to bind together the fragments 20 while providing additional characteristics (e.g., moldability; durability; tensile strength; compressive strength; impact resistance) compatible for use in the exercise weight 10. In certain implementations, the at least one second material 32 is configured to facilitate formation of the exercise weight 10 by binding fragments 20 that would otherwise not bind together without the at least one second material 32. For example, during certain fabrication processes described herein, the at least one second material 32 is configured to be in an initial solid state (e.g., a plurality of solid particles mixed with the plurality of fragments 20), to flow (e.g., melt) under applied pressure and/or heat while in a mold to substantially fill interstitial spaces between the fragments 20, and to solidify to form the matrix 30 (e.g., upon the pressure and/or heat no longer being applied). For another example, during certain fabrication processes described herein, the at least one second material 32 is configured to be in an initial liquid state, to be mixed with the plurality of fragments 20 while in a mold so as to substantially fill interstitial spaces between the fragments 20, and to solidify (e.g., upon curing) to form the matrix 30. In certain implementations, the at least one second material 32 comprises a single second material 32, while in certain other implementations, the at least one second material 32 comprises multiple second materials 32. In certain implementations, at least some of the at least one second material 32 is configured to contribute substantially to the mass of the overall exercise weight 10.

Examples of the at least one second material 32 compatible with certain implementations described herein include but are not limited to: plastics; polymers (e.g., thermoset polymers; thermoplastic polymers); elastomers (e.g., thermoset elastomers; thermoplastic elastomers); polyethylene (PE) (e.g., high density polyethylene (HDPE); medium density polyethylene (MDPE); low density polyethylene (LDPE); linear low density polyethylene (LLDPE); ultrahigh-molecular-weight polyethylene (UHMW-PE); polyethylene terephthalate glycol (PETG)); polypropylene; polyoxymethylene; polycarbonate; polybutadiene; acrylonitrile butadiene styrene (ABS); thermoplastic acrylic-polyvinyl chloride (e.g., Kydex®); polystyrene; epoxy; polyurethane; furan; urea-formaldehyde; rubber (e.g., natural rubber; polyolefinic rubber blends); thermoplastic vulcanizates (TPV); thermoplastic styrenics (TPS). There are a wide range of plastics with varied and well-known properties (e.g., tensile strength; compressive strength; impact resistance; chemical resistance) compatible with certain implementations described herein. In addition, plastics (e.g., polyethylene; polypropylene) can be very inexpensive, plentifully available (e.g., for regrinding), easily processed (e.g., not hygroscopic, thereby avoiding drying using expensive desiccant dryers prior to molding), and can have a sufficiently high impact resistance for use in an exercise weight 10. Elastomers can provide the benefits of other plastics while also providing increased stretch and elasticity (e.g., for exercise weights 10 designed to be dropped). Thermoplastic materials (e.g., plastics; elastomers) can provide the benefits of other plastics while also providing moldability (e.g., easily liquified, molded, and/or fused with pressure and/or heat) and recyclability (e.g., remolded multiple times, allowing the use of regrinding).

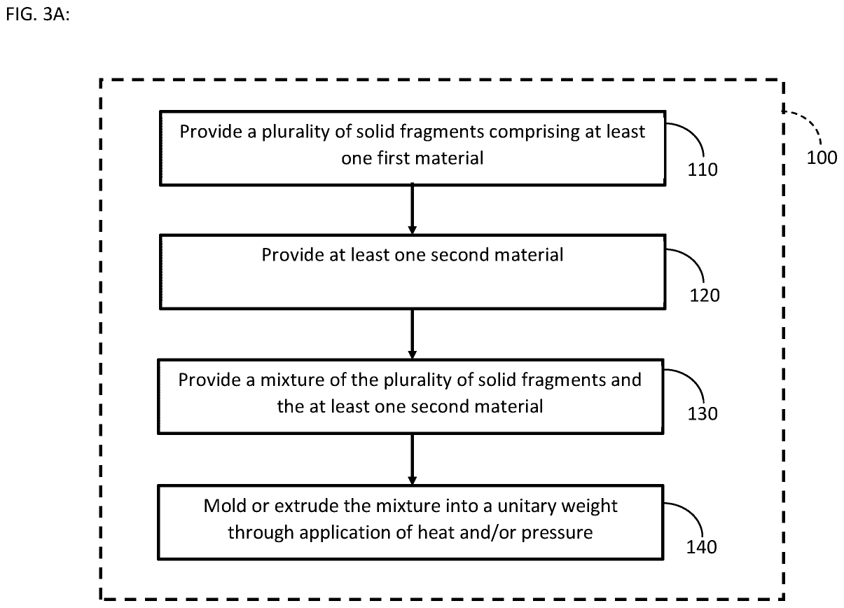

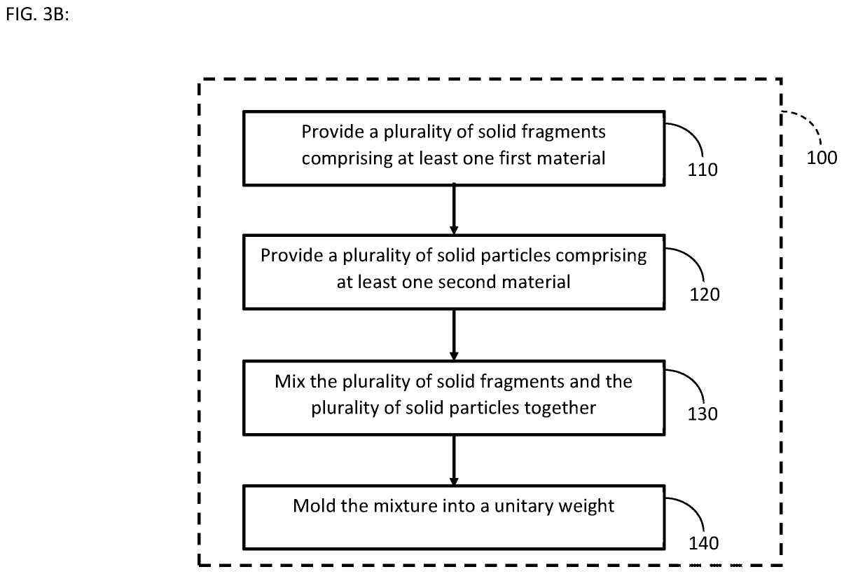

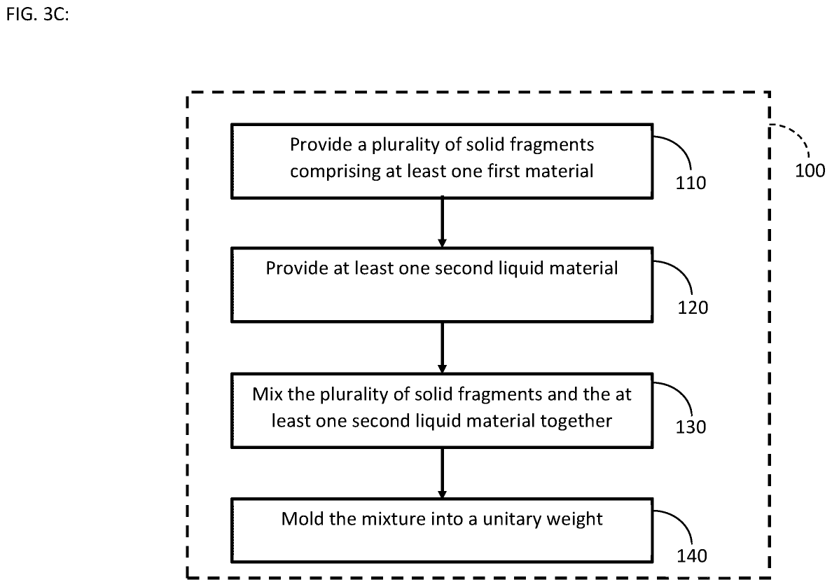

FIGS. 3A-3C schematically illustrate example methods 100 for fabricating a weight (e.g., an exercise weight 10) in accordance with certain implementations described herein. In an operational block 110, the method 100 comprises providing a plurality of solid fragments 20 comprising at least one first material 22 (e.g., at least one non-thermoplastic material, at least 75% (e.g., at least 90%) of the fragments 20 having sizes in a fragment size range). In an operational block 120, the method 100 further comprises providing at least one second material 32 (e.g., a plurality of solid particles comprising at least one thermoplastic polymer and/or elastomer material, at least 75% (e.g., at least 90%) of the particles having sizes in a particle size range). In an operational block 130, the method 100 further comprises providing a mixture 40 of the plurality of solid fragments 20 and the at least one second material 32 (e.g., forming a mixture 40 comprising 90% to 20% of the fragments 20 by volume and 10% to 80% of the particles by volume). In an operational block 140, the method 100 further comprises molding or extruding the mixture 40 into a unitary weight 10 (e.g., through the application of heat and/or pressure).

In certain implementations, providing the plurality of solid fragments 20 and providing the at least one second material 32 are performed concurrently (e.g., the solid fragments 20 and the at least one second material 32 are provided in a mixture 40 containing both the solid fragments 20 and the at least one second material 32). In certain other implementations, as illustrated by FIGS. 3B and 3C, providing the plurality of solid fragments 20 and providing the at least one second material 32 are performed separately (e.g., the solid fragments 20 are separate from the at least one second material 32 at the start of the fabrication method 100) and, the operational block 130 comprises mixing the plurality of solid fragments 20 and the at least one second material 32 together. For example, the solid fragments 20 and the at least one second material 32 can be mixed together by various techniques and/or equipment, including but not limited to: hand mixing; mixing in an electric mixer; mixing in a high viscosity mixer; mixing in an extruder; mixing in injection molding equipment; mixing in a rotary mixer (e.g., a Rollo-Mixer® rotary drum mixer available from Continental Products Corp. of Osseo, Wis.

In certain implementations, the mixture 40 has a percentage of the at least one first material 22 in a range of 90% to 20% by volume and a percentage of the at least one second material 32 in a range of 10% to 80% by volume (e.g., the at least one first material 22 in a range of 80% to 40% and the at least one second material 32 in a range of 20% to 60%; the at least one first material 22 in a range of 40% to 20% and the at least one second material 32 in a range of 60% to 80%; the at least one first material 22 in a range of 90% to 70% and the at least one second material 32 in a range of 10% to 30%; the at least one first material 22 of about 62% and the at least one second material 32 of about 38%). For first materials and/or second materials measured by volume, the volume can be calculated by measuring the mass of the material and dividing by the mass density of the material. For example, 10 grams of HDPE with a density 0.94 g/cm³ can be considered to have a volume of approximately 10.53 cm³ regardless of whether the HDPE being measured occupies a volume than larger than 10.53 cm³. For example, the volume that the HDPE actually occupies may be larger than 10.53 cm³ because the HDPE being measured is a loose powder. In certain implementations, the mixture 40 has a percentage of the at least one first material 22 in a range of 90% to 80% by mass and a percentage of the at least one second material 32 in a range of 10% to 20% by mass (e.g., 90% magnetite sand and 10% MDPE regrind; 85% magnetite sand and 15% MDPE regrind).

As shown in FIG. 3B, in certain implementations, providing the at least one second material 32 in the operational block 120 comprises providing a plurality of solid particles comprising the at least one second material 32, and forming the mixture 40 in the operational block 130 comprises mixing the plurality of solid fragments 20 and the plurality of solid particles together. For example, the at least one second material 32 can have the form of powders, pellets, and/or flakes of one or more second materials 32 (e.g., polyethylene, polypropylene, polyoxymethylene, polycarbonate, ABS, TPS, and/or TPV), regrind of one or more thermoplastics, and/or combinations thereof. In certain implementations, the solid particles comprise thermoplastic regrind which can reduce cost (since such recycled materials can be less expensive than their virgin counterparts) and can be more environmentally friendly (since such recycled materials can have reduced environmental impact as compared to producing new material).

In certain implementations, the solid particles have a range of particle sizes (e.g., comparable to or smaller than the range of fragment sizes), the size of a particle being the value of the maximum linear dimension (e.g., length, width, and/or thickness) of the particle. For example, the solid particles can have powder-sized particles (e.g., particle sizes less than 1 millimeter) that are to be mixed with fragments 20 comprising sand (e.g., fragment sizes less than 2 millimeters), gravel (e.g., fragment sizes a range of 2 millimeters to 64 millimeters), or both. For another example, the solid particles can have sand-sized particles (e.g., particle sizes less than 2 millimeters) that are to be mixed with fragments 20 comprising sand (e.g., fragment sizes less than 2 millimeters), gravel (e.g., fragment sizes a range of 2 millimeters to 64 millimeters), or both. For another example, the solid particles can have pellet-sized particles that are to be mixed with fragments 20 comprising gravel.

In certain implementations, the solid particles have a range of particle sizes that at least partially overlaps the range of fragment sizes. For example, the 90^{th} percentile of the range of particle sizes (e.g., the particle size value at which 90% of the solid particles have smaller sizes) can be less than the 10^{th} percentile of the range of fragment sizes (e.g., the fragment size value at which 10% of the solid fragments 20 have smaller sizes). For other examples, the 75^{th} percentile of the range of particle sizes can be less than the 25^{th} percentile of the range of fragment sizes or the 50^{th} percentile of the range of particle sizes can be less than the 50^{th} percentile of the range of fragment sizes.

In certain implementations, the solid particles have a range of particle sizes and the fragments 20 have a range of fragment sizes that are configured to facilitate homogeneous solid mixing of the solid particles with the fragments 20. For example, the range of particle sizes and the range of fragment sizes can be selected to reduce the amount of mixing used and/or to reduce the equipment and/or energy costs of performing the mixing (e.g., as compared to mixing the fragments 20 with a malleable, fluid, and/or liquid second material 32). In certain implementations, the range of particle sizes of the solid particles is sufficiently small such that the solid particles are more evenly distributed throughout the mixture 40 (e.g., as compared to a mixture 40 formed using solid particles having a large range of particle sizes). For example, the fragment size range can be from 0.1 millimeter to 32 millimeters and the particle size range can be from zero to 0.5 millimeter. For another example, the fragment size range can be from zero to 32 millimeters and the particle size range can be from zero to 1.5 millimeters. For another example, the fragment size range can be from 0.5 millimeter to 32 millimeters and the particle size range can be from zero to 1.5 millimeters. For another example, the fragment size range can be from 2 millimeters to 32 millimeters and the particle size range can be from zero to 10 millimeters. In certain implementations in which the solid particles have a range of particle sizes that are comparable to or smaller than the range of fragment sizes, mixing the fragments 20 with the solid particles distributes the solid particles sufficiently evenly so that when the solid particles are melted (e.g., through the application of heat and/or pressure), the fragments 20 are sufficiently encapsulated by the resulting matrix 40 without additional mixing. Because molten binding agents can be very viscous, by mixing the fragments with the binding agent while the binding agent is in a solid state, certain implementations described herein reduce (e.g., avoid) the need to mix the fragments with the binding agent while the binding agent is molten, thereby substantially reducing equipment, energy, and/or maintenance costs.

In certain implementations in which the fragments 20 are abrasive to mixing equipment (e.g., iron ores; ferrous metal chips), mixing the fragments 20 with the solid particles comprising the at least one second material 32 can reduce the abrasive effects of the fragments 20 (e.g., as compared to mixing the fragments 20 with a liquid form of the at least one second material 32). For example, mixing equipment intended for use with powders and granules is less costly to replace than high viscosity mixing equipment and/or is less likely to be degraded by the abrasive fragments 20 than is high viscosity mixing equipment.

As shown in FIG. 3C, in certain implementations, providing the at least one second material 32 in the operational block 120 comprises providing at least one second liquid material having a second mass density less than the first mass density, and forming the mixture 40 in the operational block 130 comprises mixing the plurality of solid fragments 20 and the at least one second liquid material together. For example, the at least one second material 32 can have a liquid, malleable, and/or molten form.

In certain implementations, molding or extruding the mixture 40 into a unitary weight 10 in the operational block 140 comprises transferring the mixture 40 into a mold 200. The techniques and/or equipment used to transfer the mixture 40 into the mold 200 can depend on the container holding the mixture 40 (e.g., the container in which the solid fragments 20 and the at least one second material 32 are mixed together). For example, the mixing equipment can include a dispensing portion configured to transfer the mixture 40 from the container into the mold 200, and examples of such a dispensing portion include but are not limited to: an extruder outlet; an injection molding machine; a rotary mixer outlet. In certain implementations, the mixture 40 can be transferred by hand (e.g., using a tool such as a spoon or scoop). In certain implementations, prior to transferring the mixture 40 into the mold 200, an inner surface of the mold 200 is lined (e.g., coated; rotomolded) with a material (e.g., plastic; rubber; other second materials 32 as discussed herein) configured to become the outer surface of the fabricated unitary weight 10 (e.g., rather than the outer surface becoming a surface of the solid fragments 20 and the matrix 30).

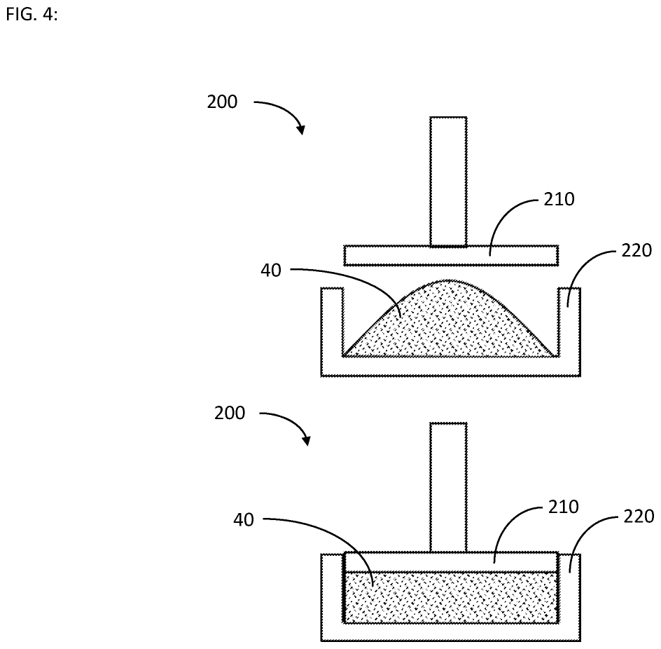

In certain implementations, after the mixture 40 is transferred into the mold 200, molding or extruding the mixture 40 comprises applying pressure and/or heat to the mixture 40 within the mold 200 for a period of time and ceasing applying the pressure and/or the heat to the mixture 40 within the mold 200. For example, in certain implementations in which a plurality of solid particles comprises the at least one second material 32, the pressure and/or heat can be sufficient to melt the solid particles and ceasing applying the pressure and/or the heat can allow the at least one second material 32 to solidify (e.g., forming the matrix 30) and bind the solid fragments 20 to one another. FIG. 4 schematically illustrates an example mold 200 containing the mixture 40 in accordance with certain implementations described herein. The mold 200 comprises a first portion 210 and a second portion 220 configured to apply mechanical pressure to the mixture 40. In certain implementations, the mold 200 comprises or is in mechanical communication with a mechanical press (e.g., arbor press; manually-applied press; hydraulic press; pneumatic press; weight of the first portion 210 or placed on the first portion 210). As schematically illustrated in FIG. 4, the mixture 40 within the mold 200 can be redistributed within the mold 200 to completely fill the region bounded by the first portion 210 and the second portion 220. For example, the pressure applied by the mold 200 to the mixture 40 can be at least 10 pounds and can be applied for a time period of at least 1 second, such that the mixture 40 is distributed substantially uniformly in the mold 200. In certain implementations, the mold 200 is held closed (e.g., clamped) for another time period during which the distribution of the mixture 40 is maintained until the second material 32 sets (e.g., solidifies). In certain implementations, a pressure of 0.1 psi to 5000 psi is applied, either intermittently or continuously, during the molding process (e.g., which can improve the surface finish of the fabricated unitary weight 10).

In certain implementations, the mixture 40 is heated while in the mold 200 (e.g., while pressure is applied by the mold 200 to the mixture 40). For example, the mixture 40 within the mold 200 can be heated in an oven, conveyor oven, and/or batch oven and/or heated with a hot plate or heating platen of a compression molding machine. In certain implementations in which the second material 32 comprises one or more thermoplastic materials, the mold 200 and the mixture 40 can be heated to the melting point of the one or more thermoplastic materials (e.g., to aid distribution of the mixture 40 within the mold 200).

### Example Implementations

In certain implementations, the mixture 40 is transformed into a composite material unitary weight 10 that has the predetermined size and shape (e.g., determined by the mold 200).

In a first example implementation, the at least one second material 32 comprises a fluid (e.g., liquid) material. For example, the fluid material can comprise a thermoset material (e.g., IE-3075 and/or a melted thermoplastic material such as polyethylene). If not already mixed together, the solid fragments 20 and the at least one second fluid material 32 can be mixed together. The mixture 40 is transferred into the mold 200 and further processing can be applied to the mixture 40 and the mold 200. The at least one second fluid material 32 can be allowed to set, forming a solid composite material with the solid fragments 20 bound together by the matrix 30. The unitary weight 10 can then be removed from the mold 200.

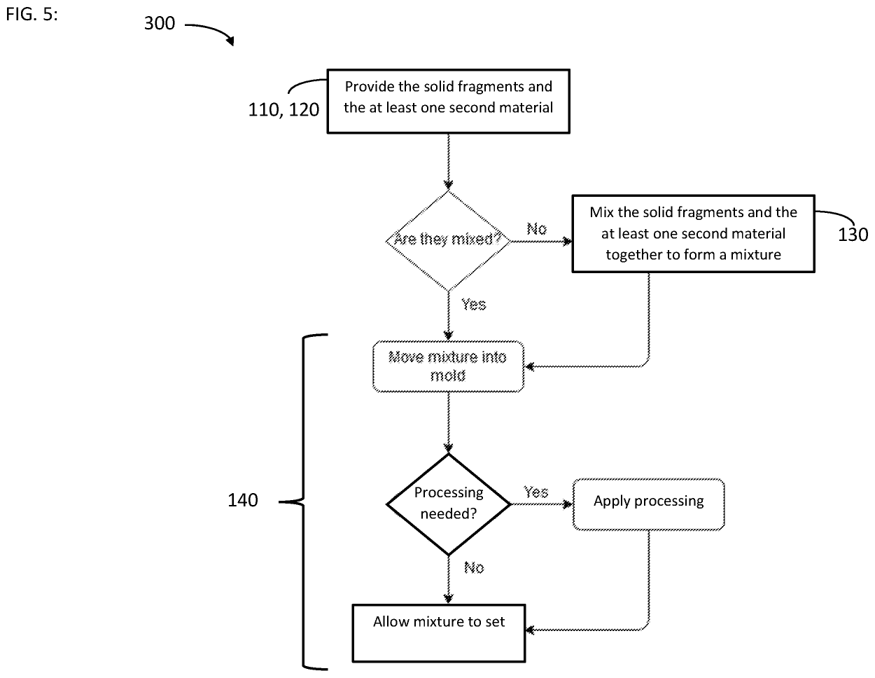

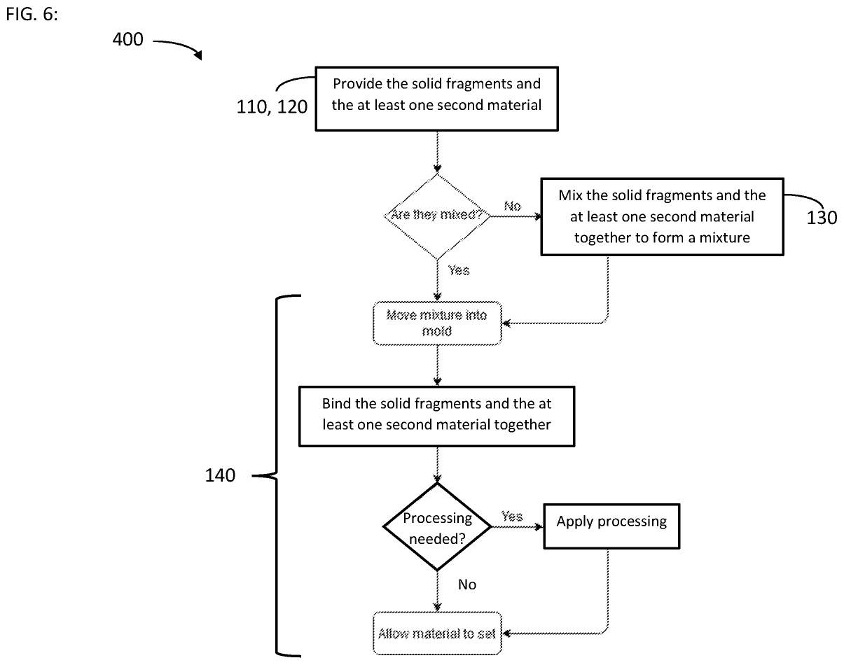

FIGS. 5 and 6 are flow diagram of two example methods 300, 400 in accordance with certain implementations described herein. The mixture 40 can comprise the solid fragments 20 and a plurality of solid particles comprising the at least one second material 32 (e.g., having a range of particle sizes that is comparable to or less than the range of fragment sizes). For example, the solid particles can comprise a powdered thermoplastic material (e.g., polyethylene; TPV) and the solid fragments 20 can comprise coarse magnetite sand, magnetite gravel, iron ore sand, iron ore gravel, ferrous metal chips, and/or scrap metal chips. If not already mixed together, the solid fragments 20 and the plurality of solid particles can be mixed together (e.g., in operational block 130). In certain implementations, the mixture 40 is moved into the mold 200 with the at least one second material 32 remaining as solid particles (e.g., FIG. 5), while in certain other implementations, the mixture 40 is heated (e.g., prior to being moved into the mold 200) such that the at least one second material 32 is fluid and/or malleable (e.g., the solid particles are melted) and is then moved into the mold 200. As seen in FIG. 6, the at least one second material 32 can be bound to itself and to the solid fragments 20 (e.g., by applying pressure, heat, and/or other processing steps) after moving the mixture 40 into the mold 200. Further processing (e.g., pressure and/or heat) can be applied to the mixture 40 while within the mold 200. For example, heat can be applied to the mixture 40 while in the mold 200, the heat sufficient to make the solid particles fluid and/or malleable (e.g., to melt the solid particles) and/or to keep the at least one second material 32 fluid for a predetermined time period. Application of the heat can be stopped and the at least one second material 32 can be allowed to cool and/or set, forming a solid composite material with the solid fragments 20 bound together by the matrix 30. The unitary weight 10 can then be removed from the mold 200. In certain implementations, equipment (e.g., an extruder or injection molding machine) can perform multiple roles in the fabrication process (e.g., heating the at least one second material 32 and/or the mixture 40, mixing the solid fragments 20 and the at least one second material 32, and/or moving the mixture 40 into the mold 200).

In certain implementations, the solid fragments 20 and the at least one second material 32 are mixed together while the at least one second material 32 is not in a liquid state (e.g., the at least one second material 32 comprises a plurality of solid particles). The solid particles of the at least one second material 32 can have a range of particle sizes that is sufficiently smaller than the range of fragment sizes of the solid fragments 20 so that the at least one second material 32 can be mixed homogeneously with the solid fragments 20 while still in a solid state. In addition, the solid particles of the at least one second material 32 can be sufficiently close together such that the solid particles can connect together (e.g., bind; cure) to form the matrix 30 which binds the solid fragments 20 together to form the unitary composite weight 10. For example, for a second material 32 comprising a thermoplastic material, the mixture 40 of the second material 32 and the solid fragments 20 can be heated to melt the second material 32 such that the solid particles of the second material 32 then meld together, binding to themselves and to the solid fragments 20. In certain implementations, the at least one second material 32 (e.g., thermoplastic material) can be formed and/or molded multiple times, and instead of allowing the mixture 40 to set in the mold 200 to form the final weight 10, the bound and homogeneous mixture 40 can be extruded (e.g., for repalletization) or otherwise processed to allow the bound and homogenous mixture 40 to be used in a future molding process.

In certain implementations, the mixture 40 of solid particles and solid fragments 20 is under vacuum prior to and/or during melting or curing the solid particles. For example, the mixture 40 can be under a vacuum with an absolute pressure less than 3 psi (e.g., less than 0.5 psi). Melting the particles while they are under vacuum can significantly reduce the amount of air that becomes trapped in the final product, resulting in a denser, less porous product.

In certain implementations, the method 400 further comprises adding a layer of at least one second material 32 (which is not mixed with the solid fragments 20) to the mold 200 prior to transferring the mixture 40 to the mold 200. In certain implementations, after the mixture 40 has been transferred to the mold 200 (e.g., distributed in the mold 200 as desired), the method 400 comprises adding a layer of at least one second material 32 (which is not mixed with the solid fragments 20) on top of the mixture 40. Adding layers of the at least one second material 32 which are not mixed the mixture 40 (e.g., to the top and/or bottom of the mold 200) can enhance the surface finish of the molded composite unitary weight 10. For example, these additional layers can be less than or equal to 3 millimeters thick or less than or equal to 6 millimeters thick. In certain implementations in which the mold 200 is textured and/or engraved (e.g., having indentations and/or protrusions that result in corresponding protrusions and/or indentations on the molded unitary weight 10), these layers can be conformal (e.g., covering the entire surface) or can cover only flat portions of the surface. In certain implementations, the layers can be added to the mold 200 by using a sifter.

In certain implementations, the method 100, 300, 400 further comprises adding at least one component to the weight 10 to make a final product (e.g., adding the at least one component during the molding process and/or after the weight 10 is molded). For example, the at least one component can comprise a ring inserted in the center of a weight 10 (e.g., plate), the ring configured to facilitate the durability of the weight 10 (as that portion of the weight 10 is subjected to more wear and tear) and/or to facilitate moving the weight 10 onto and off of a weight bar. Examples of materials for a ring compatible with certain implementations described herein include but are not limited to: stainless steel, aluminum, other metals, and/or the at least one second material 32 as described herein. In certain implementations, the ring is notched so as to facilitate the ring not being displaced. For another example, the at least one component can comprise a handle (e.g., comprising metal; stainless steel, iron; chromed steel) inserted into the weight 10 to form a dumbbell weight. For another example, the at least one component can comprise a coating (e.g., natural rubber; polyurethane; and/or neoprene coating) over all or part of the weight 10, the coating configured to facilitate sealing the weight 10 and/or to provide improved grip and/or cushioning to the user.

Certain implementations described herein provide significant benefits over weights comprising concrete and weights comprising masticated rubber. While concrete weights and masticated rubber weights are fabricated by combining an inert material with a binding agent, one benefit of certain implementations described herein derives from the use of thermoplastic binding agents. Thermoplastic resins provide significantly greater tensile strength and impact resistance as compared to the cement used in concrete weights, such that certain implementations described herein are significantly more durable than concrete weights. Another benefit of certain implementations described herein derives from thermoplastics being typically less expensive than the thermoset polyurethane of the masticated rubber used in some bumper plates. Thus, certain implementations described herein are more cost effective than masticated rubber weights.

Another benefit of certain implementations described herein derives from the use of ferrous ores and metals as a density provider (e.g., as the fragments). Ferrous ores (e.g., magnetite) are significantly denser than gravel which is typically used in concrete weights and crumb rubber which is typically used in bumper plates. Thus, the use of ferrous ores of certain implementations described herein allows for the creation of a denser more compact weight as compared to concrete weights or masticated rubber weights.

As described herein, the use of thermoplastic binding agents can be facilitated by having the thermoplastic binding agents in a solid form with a particle size range comparable to or less than the fragment size range. While many thermoplastic polymers are less expensive than the thermoset polyurethane often used in weights, the cost associated with blending or mixing the thermoplastic polymers using conventional techniques can outweigh the savings gained from using the cheaper thermoplastic material. Certain implementations described herein use combinations of thermoplastic particle sizes and fragment sizes that allow the thermoplastic particles and non-thermoplastic fragments to be mixed (e.g., homogenously) while the thermoplastic particles are solid, thereby significantly reducing the cost of mixing. Thus, certain implementations described herein use the cheaper thermoplastic materials more economically as compared to conventional techniques. Certain implementations described herein also allow the mixture to be placed in a mold while the particles are in a solid form, further reducing equipment and material handling costs.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of conventional auditory prostheses, various implementations described herein can be incorporated in a variety of other suitable devices, methods, and contexts. More generally, as can be appreciated, certain implementations described herein can be used in a variety of contexts that can benefit from having a composite unitary form.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein, but should be defined only in accordance with the claims and their equivalents.

1. A method for fabricating a unitary element comprising a composite material, the method comprising:
providing a plurality of solid fragments comprising at least one non-thermoplastic material having a mass density greater than 3500 kg/m³;
providing a plurality of solid particles comprising at least one thermoplastic polymer and/or elastomer material, at least 75% of the solid fragments having sizes in a fragment size range from 0.1 millimeter to 32 millimeters and at least 75% of the solid particles having sizes in a particle size range from zero to 1.5 millimeters;
forming a mixture of the plurality of solid fragments and the plurality of solid particles, the mixture comprising 80% to 20% of the fragments by volume and 20% to 80% of the particles by volume; and
molding or extruding the mixture into a unitary element through the application of heat and/or pressure.

2. The method of claim 9, wherein at least 75% of the solid particles have sizes in the particle size range from zero to 0.5 millimeter, and at least 75% of the solid fragments have sizes in the fragment size range from 0.5 millimeter to 32 millimeters.

3. The method of claim 9, wherein at least 75% of the solid fragments have sizes in the fragment size range from 1.5 millimeters to 32 millimeters and at least 75% of the solid particles have sizes in the particle size range from zero to 1.5 millimeters.

4. The method of claim 9, wherein the at least one non-thermoplastic material comprises ferrous metal, and/or ferrous scrap metal.

5. The method of claim 9, wherein the at least one non-thermoplastic material comprises magnetite or iron ore.

6. The method of claim 9, wherein the unitary element comprises an exercise weight.

7. The method of claim 9, wherein said molding or extruding the mixture comprises applying heat and/or pressure sufficient to flow the at least one thermoplastic polymer and/or elastomer material to substantially fill interstitial spaces between the fragments.

8. The method of claim 9, further comprising placing the mixture under a vacuum with an absolute pressure less than 3 psi prior to and/or during the application of heat and/or pressure.

9. The method of claim 1, wherein the mixture is molded through the application of heat and/or pressure and molding the mixture into a unitary element comprises:
placing the mixture into a mold while the at least one thermoplastic polymer and/or elastomer material remains as solid particles;
applying pressure and/or heat to the mixture within the mold, the pressure and/or heat sufficient to melt the solid particles; and
ceasing applying the pressure and/or the heat to the mixture within the mold such that the at least one thermoplastic polymer and/or elastomer material solidifies and binds the solid fragments to one another.

10. (canceled)

11. An exercise weight comprising:
a plurality of fragments comprising at least one first solid material with a first mass density greater than 3500 kg/m³ and at least 75% of the fragments having sizes in a fragment size range from 0.1 millimeter to 32 millimeters; and
a matrix that binds the plurality of fragments to one another, the matrix comprising at least one thermoplastic polymer and/or elastomer,
wherein the exercise weight comprises 80% to 20% of the fragments by volume and 20% to 80% of the matrix by volume.

12. The exercise weight of claim 11, wherein at least 75% of the fragments have sizes in the fragment size range from 0.5 millimeter to 32 millimeters.

13. The exercise weight of claim 11, wherein at least 75% of the fragments have sizes in the fragment size range of 1 millimeter to 4 millimeters.

14. The exercise weight of claim 11, wherein the at least one first solid material comprises a ferrous metal.

15. The exercise weight of claim 11, wherein the at least one first solid material of at least some of the fragments is selected from the group consisting of: magnetite and iron ores.

16. The exercise weight of claim 11, wherein the at least one thermoplastic polymer and/or elastomer is selected from the group consisting of: polyethylene and polypropylene.

17.-21. (canceled)

22. The method of claim 9, wherein the mixture comprises 90% to 80% of the fragments by mass and 10% to 20% of the particles by mass.

23. The exercise weight of claim 11, wherein the exercise weight comprises 90% to 80% of the fragments by mass and 10% to 20% of the matrix by mass.

24. The method of claim 9, wherein at least 75% of the solid particles have sizes in the particle size range from zero to 0.5 millimeter, and at least 75% of the solid fragments have sizes in the fragment size range from 0.1 millimeter to 4 millimeters.

25. The method of claim 9, wherein at least 75% of the solid particles have sizes in the particle size range from zero to 0.5 millimeter, and at least 75% of the solid fragments have sizes in the fragment size range from 0.25 millimeter to 4 millimeters.

26. The method of claim 9, wherein at least 75% of the solid particles have sizes in the particle size range from zero to 0.5 millimeter, and at least 75% of the solid fragments have sizes in the fragment size range from 0.5 millimeter to 4 millimeters.
